(19) United States
(12) Patent Application Publication
(10) Pub. No.: US 2016/0124687 A1
(43) Pub. Date: May 5, 2016

(54) Printing Device and Control Method of a Printing Device

(71) Applicant: Seiko Epson Corporation, Tokyo (JP)

(72) Inventors: Hiroki Shinagawa, Matsumoto-shi (JP); Ryuji Moriyama, Matsumoto-shi (JP)

(21) Appl. No.: 14/924,029

(22) Filed: Oct. 27, 2015

(30) Foreign Application Priority Data
Oct. 30, 2014 (JP) 2014-221191

(51) Int. Cl. G06F 3/12; B41J 13/00; G06K 15/02

(52) U.S. Cl. CPC G06F 3/1211; G06F 3/1217; G06F 3/1237; G06F 3/1282; G06K 15/021; B41J 13/0009

(57) ABSTRACT

A printing device improves the conveyance precision when printing on a print medium that changes the conveyance load. A printing device has a main feed roller 33 driven by a main feed motor 43 to convey a print medium P with a variable conveyance load, a print unit 13 that prints on the print medium P conveyed by the main feed roller 33, a current detector 66 that detects change in the current supplied to the supply motor 41 according to variation in the conveyance load, and a control unit 14 that controls driving the main feed motor 43. The control unit 14 changes a control parameter of the main feed motor 43 according to change in the current to maintain a target conveyance precision of the print medium P.

### BACKGROUND

1. Technical Field

The present invention relates to a printing device and to a control method of a printing device that prints while conveying a print medium having a variable conveyance load.

2. Related Art

Inkjet line printers that print on label paper having labels of a fixed size affixed to a liner as described in JP-A-2013-169778 are an example of this type of printing device.

The printer described in JP-A-2013-169778 has a printhead that prints on label paper, a paper feed roller that conveys the label paper past the printing position of the printhead, a paper feed motor that drives the paper feed roller, and a control means that controls the paper feed motor.

The control means uses PID (proportional-integral-derivative) control to control the paper feed motor when printing. In this event, the control means computes the current position and current speed of the label paper, and calculates the speed deviation, which is the difference between the target speed and the current speed. The control means then calculates a proportional control value, integral control value, and derivative control value from the speed deviation, outputs a control signal equivalent to the sum of these values to the motor driver, and controls the paper feed motor by feedback control (PID control).

More specifically, the control means sets the gain for calculating each of the proportional, integral, and derivative control values higher in the conveyance interval where the stepped area including the edges of adjacent labels passes the paper feed roller than in the other conveyance intervals. By thus increasing the gain parameter for PID control in the stepped area where the conveyance speed can easily change, the conveyance speed can be stabilized and high print quality can be maintained.

This printer can convey label paper having two areas of different thickness, the parts where only the liner is present and the parts where the label is also present, at a stable conveyance speed. With a pamphlet or booklet such as a bank passbook, however, the thickness varies according to the number of pages, the feed load changes when the thickness changes, and maintaining a consistent conveyance speed is difficult.

### SUMMARY

A printing device and a control method of a printing device according to the invention improve the conveyance precision when printing on print media with a variable conveyance load.

A printing device according to one aspect of the invention has a media conveyance unit that is driven by a DC motor and conveys an open booklet; a print unit that prints on the booklet conveyed by the media conveyance unit; a current detection unit that detects the current supplied to the DC motor; and a control unit that controls driving the DC motor based on a control parameter, and changes the control parameter of the DC motor according to change in the current detected by the current detection unit.

Preferably, the current changes according to change in the conveyance load on the DC motor during conveyance of the booklet.

This aspect of the invention detects change in the current supplied to the DC motor, and changes a control parameter of the DC motor according to the change in current. In other words, a control parameter of the DC motor is changed according to the conveyance load of the print medium. The conveyance precision, including the conveyance speed and stop position of the print medium, can therefore be increased when printing (during printing conveyance).

Print quality when printing on special print media such as bound booklets can therefore be improved.

Further preferably, the control unit has a control table storing the control parameter corresponding to the current detected by the current detection unit.

This configuration simplifies the configuration of the control unit and improves response.

Further preferably, the print unit has an inkjet head that moves in a main scanning direction; and the media conveyance unit intermittently conveys the print medium (booklet) in a direction perpendicular to the main scanning direction synchronized to driving the inkjet head.

This aspect of the invention can improve the precision of intermittent conveyance of the print medium in the sub-scanning direction during inkjet printing. Print quality can therefore be improved.

Further preferably, the control parameter includes a gain parameter for PID (proportional-integrative-derivative) control.

This aspect of the invention easily and effectively improves the conveyance precision of the print medium.

Further preferably, the media conveyance unit includes a media conveyance roller driven by the DC motor that conveys the booklet to the print unit.

This aspect of the invention enables detecting the current supplied to the DC motor and controlling the DC motor based on the detected current in real time.

Yet further preferably, the media conveyance unit includes a media conveyance roller that conveys the booklet to the print unit, and a supply conveyance roller that supplies the booklet to the media conveyance roller; the DC motor includes a first motor that drives the media conveyance roller, and a second motor that drives the supply conveyance roller; the current detection unit detects change in the current of the second motor; and the control unit changes the control parameter of the first motor according to change in the current of the second motor.

By detecting change in the current of the second motor, and controlling the first motor based on the detected current, this aspect of the invention can precisely and consistently intermittently convey the print medium when printing.

Further preferably, the control unit sets a threshold value according to change in the current detected by the current detection unit, and stops the DC motor when the detected current exceeds the threshold value.

Print media such as bound booklets that cause the conveyance load to change have multiple different places where the thickness differs in the conveyance direction. As a result, paper jams and other problems occur differently at different places, and the value for detecting overloading the DC motor due to paper jams, for example, therefore preferably changes.

This aspect of the invention sets the threshold value for determining motor overload according to change in the current, and can therefore more appropriately detect paper jams under different conditions.

Another aspect of the invention is a control method of a printing device that conveys an open booklet driven by a DC motor when printing, the control method including: detecting the current supplied to the DC motor; changing a control parameter of the DC motor according to change in the detected current; and driving the DC motor based on the control parameter.

This aspect of the invention detects change in the current supplied to the DC motor, and changes a control parameter of the DC motor according to the change in current. In other words, a control parameter of the DC motor is changed according to the conveyance load of the print medium. The conveyance precision, including the conveyance speed and stop position of the print medium, can therefore be increased when printing (during printing conveyance).

Print quality when printing on special print media such as bound booklets can therefore be improved.

Other objects and attainments together with a fuller understanding of the invention will become apparent and appreciated by referring to the following description and claims taken in conjunction with the accompanying drawings.

### BRIEF DESCRIPTION OF THE DRAWINGS

FIG. 1 is an external oblique view from the front of a printing device according to a preferred embodiment of the invention.

FIG. 2 is an external oblique view from the back of a printing device according to a preferred embodiment of the invention.

FIG. 3 is a section view of the printing device according to this embodiment of the invention.

FIGS. 4 (a), 4 (b) and 4 (c) illustrate a booklet as an example of the print medium.

FIG. 5 shows an example of a control table.

FIG. 6 is a flow chart of controlling conveyance of a booklet.

### DESCRIPTION OF EMBODIMENTS

Preferred embodiments of a printing device and a control method of a printing device according to the present invention are described below with reference to the accompanying figures.

The printing device in this embodiment is a serial inkjet line printer capable of color printing on print media including single cut-sheet forms and such booklets as bank passbooks. The printer applies special conveyance control when conveying booklets (print medium) for printing.

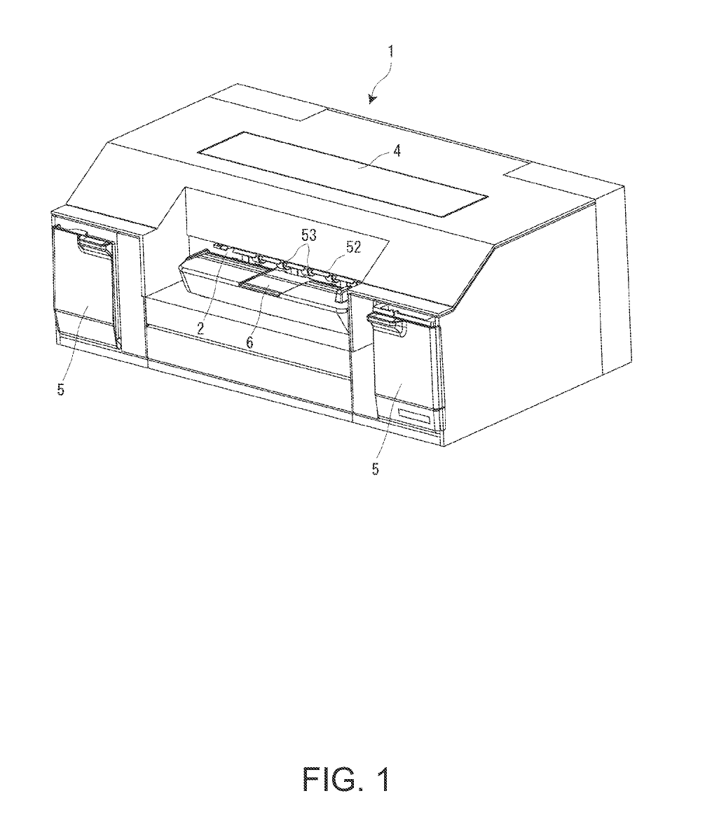

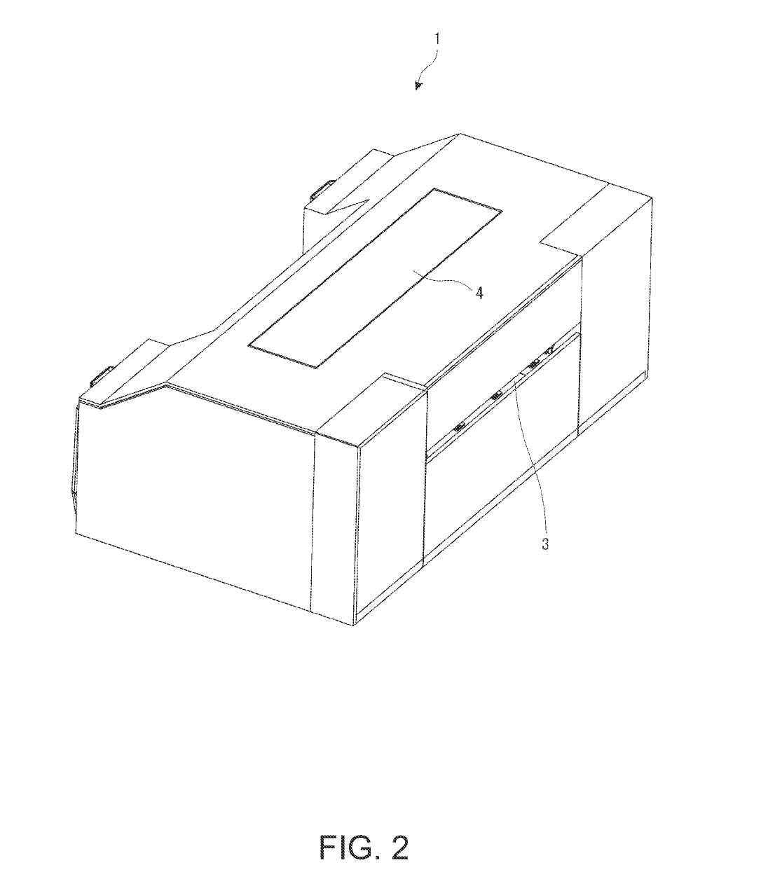

FIG. 1 and FIG. 2 are external oblique views of the printing device. As shown in the figures, the printing device 1 has a paper supply opening 2 formed as a horizontally long opening in the front center, and a paper exit 3 formed as a horizontally long opening in the back center. An operating panel 4 including a display is disposed on the top of the printing device 1, and a pair of right and left access doors 5 for installing and removing ink cartridges are disposed to the right and left sides at the front. A shallow insertion guide channel 6 is disposed in the middle of the paper supply opening 2, and a booklet PA inserted as the print medium P to the paper supply opening 2 is guided by the insertion guide channel 6.

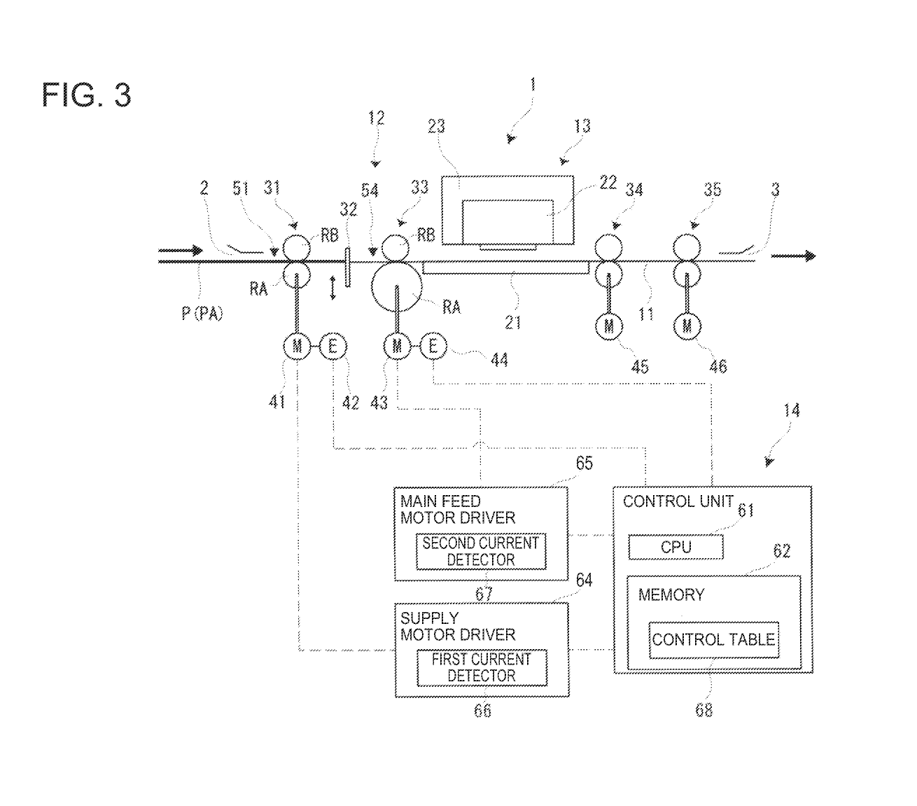

As shown in the section view in FIG. 3, the printing device 1 has a conveyance path 11 going horizontally from the paper supply opening 2 to the paper exit 3; a media conveyance unit 12 disposed near the conveyance path 11 for conveying the print medium P; a print unit 13 facing the middle of the conveyance path 11 for printing on the print medium P conveyed by the media conveyance unit 12; and a control unit 14 for controlling the media conveyance unit 12 and print unit 13, for example.

While not shown in the figure, a magnetic head for reading a magnetic stripe on a passbook or other booklet PA is also disposed near the paper supply opening 2.

The print unit 13 includes a platen 21 as part of the conveyance path 11; an inkjet head 22 opposing the platen 21 with a specific gap (a so-called paper gap) therebetween; and a carriage 23 that carries the inkjet head 22.

Not shown in the figure, the print unit 13 also includes a head moving mechanism for moving the inkjet head 22 in a main scanning direction perpendicular to the conveyance path 11 by way of the carriage 23, and a maintenance mechanism for the inkjet head 22.

In order from the paper supply opening 2 to the paper exit 3, the media conveyance unit 12 has a supply roller 31 (supply conveyance roller), alignment plate 32, main feed roller 33 (media conveyance roller), secondary conveyance roller 34, and a discharge roller 35.

The media conveyance unit 12 also includes a supply motor 41 that drives the supply roller 31; a main feed motor 43 that drives the main feed roller 33; a secondary conveyance motor 45 that drives the secondary conveyance roller 34; and a discharge motor 46 that drives the discharge roller 35.

The media conveyance unit 12 also includes a supply encoder 42 that detects the rotational speed of the supply motor 41, and a main feed encoder 44 that detects the rotational speed of the main feed motor 43.

The supply motor 41, main feed motor 43, secondary conveyance motor 45, and discharge motor 46 are DC motors, and respectively drive the supply roller 31, main feed roller 33, secondary conveyance roller 34, and discharge roller 35 through a gear train or other power transfer mechanism. Note that the main feed motor 43 and secondary conveyance motor 45 may be the same motor, or the secondary conveyance motor 45 and discharge motor 46 may be the same motor.

The supply roller 31, main feed roller 33, secondary conveyance roller 34, and discharge roller 35 are nip rollers each including a drive roller RA and a driven roller RB. The driven roller RB is urged by a spring, for example, to the drive roller RA. As a result, the feed load on the motor that drives the drive roller RA is greater when conveying a thick print medium P than when conveying a thin print medium P. The conveyance precision of the main feed roller 33 (main feed motor 43) that directly contributes to the printing operation is particularly affected by variation in the conveyance load as described further below.

The supply roller 31 is disposed near the paper supply opening 2, and the print medium P inserted from the paper supply opening 2 is fed by the supply roller 31 to the main feed roller 33.

An insertion detector 51 comprising an optical sensor or microswitch, for example, is disposed on the upstream side of the supply roller 31. When the insertion detector 51 detects the leading end of the print medium P inserted to the paper supply opening 2, the control unit 14 drives the supply roller 31 through the supply motor 41. By driving the supply roller 31, the leading end of the print medium P is nipped by the drive roller RA and driven roller RB of the supply roller 31, and conveyance of the print medium P starts. When the insertion detector 51 detects the trailing end of the print medium P, the print medium P is conveyed the number of steps equal to the distance between the insertion detector 51 and supply roller 31, driving the supply roller 31 stops after turning this number of steps, and conveyance of the print medium P by the supply roller 31 ends.

The supply roller 31 has plural rollers 53 disposed with gaps therebetween along a roller shaft 52 (see FIG. 1), and the individual rollers 53 can slip against the print medium P.

The alignment plate 32 on the downstream side of the supply roller 31 is moved between a down position below the conveyance path 11 and a raised position protruding above the conveyance path 11 by a lift mechanism not shown. When the alignment plate 32 is in the up position and the print medium P (booklet PA) is advanced by the supply roller 31, the leading end of the print medium P contacts the alignment plate 32. If conveyance of the print medium P then continues, the plural rollers 53 of the supply roller 31 turn or slip appropriately. As a result, the full width of the print medium P is pushed against the alignment plate 32, and biasing of the print medium P (booklet PA) is corrected (the print medium P is aligned).

While not shown in the figures, an alignment detector that detects of alignment of the print medium P is also provided. When alignment of the print medium P is detected by the alignment detector, the control unit 14 stops driving the supply roller 31, moves the alignment plate 32 to the down position below the conveyance path 11, and resumes driving the supply roller 31.

A paper feed detector 54 that detects the print medium P is disposed on the downstream side of the alignment plate 32. The paper feed detector 54 detects the leading end of the print medium P, and the print medium P is indexed based on the output from the paper feed detector 54. The paper feed detector 54 also detects the trailing end of the print medium P conveyed by the main feed roller 33. The paper feed detector 54 may be an optical sensor or microswitch, for example. When the leading end of the print medium P is detected by the paper feed detector 54, driving the main feed roller 33, secondary conveyance roller 34, and discharge roller 35 starts.

After the leading end of the print medium P passes the main feed roller 33 and the printing operation of the print unit 13 starts, the conveyance operation of the main feed roller 33 changes from continuous conveyance to printing conveyance (intermittent conveyance). The print unit 13 is driven synchronized to this printing conveyance by the main feed roller 33.

More specifically, the print medium P is conveyed for printing by the main feed roller 33, and synchronized thereto the inkjet head 22 is moved in the main scanning direction of the inkjet head 22 by the head moving mechanism and the inkjet head 22 is driven to eject ink. As a result, the print medium P is printed on based on the print data acquired by the printing device 1.

The secondary conveyance roller 34 rotates at a slightly greater speed than the main feed roller 33 and slips so that the print medium P is conveyed with desirable tension applied by the secondary conveyance roller 34. As a result, the print medium P is conveyed along the platen 21, and a desirable paper gap (a paper gap within a tolerance range) is maintained between the surface of the print medium P and the nozzle face of the inkjet head 22.

When printing on the print medium P ends, the print medium P is discharged from the paper exit 3 by the secondary conveyance roller 34 and discharge roller 35. Note that the actual conveyance path 11 is short, and when the downstream half of the booklet PA (the leading end area 56 described below) is at the printing position of the print unit 13, the upstream half (the trailing end area 57 described below) is at the supply roller 31. When the upstream half is at the printing position of the print unit 13, the downstream half is already at the discharge roller 35.

This embodiment describes an example in which the secondary conveyance roller 34 and discharge roller 35 rotate and the print medium P is discharged from the paper exit 3, but these rollers may alternatively be controlled to rotate in the opposite direction in which the print medium P is discharged from the paper exit 3 and discharge the print medium P from the paper supply opening 2.

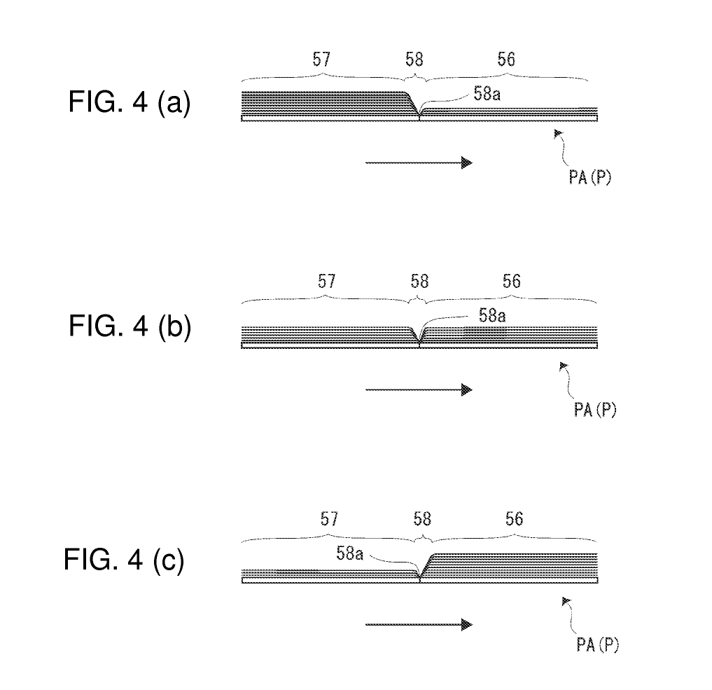

FIG. 4 shows different examples of how the booklet PA may be opened when printing on the booklet PA. For example, FIG. 4 (a) shows when the leading end area 56 on the downstream side in the conveyance direction of the booklet PA contains few pages and is relatively thin, and the trailing end area 57 on the upstream side has more pages and is thick. FIG. 4 (b) shows when the thickness of the leading end area 56 and the thickness of the trailing end area 57 are substantially the same. FIG. 4 (c) shows when the leading end area 56 of the booklet PA is thick and the trailing end area 57 is thin. In all cases, the binding area 58 around the binding 58a of the booklet PA is the thinnest.

The number of pages that are turned in the booklet PA thus differs according to which page is being printed, and the open thicknesses of the leading end area 56 and trailing end area 57 differ. More specifically, the booklet PA only has a specific number of pages, and the booklet PA may be opened in many ways with a different number of pages on each side of the binding 58a. The thickness also differs in the leading end area 56, trailing end area 57, and binding area 58, and the thickness held by the main feed roller 33 changes during the printing conveyance operation.

As described above, when the thickness between the drive roller RA and driven roller RB changes, the conveyance load on the drive roller RA is also changes. As a result, when the thickness of the print medium P held by the drive roller RA and driven roller RB of the main feed roller 33 changes, the conveyance load of the main feed motor 43 that drives the main feed roller 33 changes. Change in the conveyance load on the main feed motor 43 affects the conveyance precision (conveyance speed and stopping precision) in the printing conveyance operation. The printing device 1 according to this embodiment therefore controls conveyance of the booklet PA when printing to maintain desirable conveyance precision.

The control configuration for controlling the media conveyance unit 12, including the main feed motor 43, is described next with reference to FIG. 3.

The media conveyance unit 12 is controlled by a control unit 14 including a CPU 61 and memory 62 (ROM, RAM); a supply motor driver 64 that controls the supply motor 41; and a main feed motor driver 65 that controls the main feed motor 43.

The supply motor driver 64 has a first current detector 66 that detects change in the current supplied to the supply motor 41 (DC motor).

The main feed motor driver 65 has a second current detector 67 that detects change in the current supplied to the main feed motor 43 (DC motor).

The memory 62 of the control unit 14 stores a control table 68 that is referenced when printing on a booklet PA. As described in further detail below, the control unit 14 acquires the detection result of the first current detector 66 of the supply motor driver 64, references the control table 68 based on the detector output, and controls the main feed motor 43 through the main feed motor driver 65. In this event, the control unit 14 applies PID control (feedback control) of the main feed motor 43, which is a DC motor.

When the booklet PA is supplied for printing as shown in FIG. 4 (a), the conveyance load on the main feed roller 33 when the booklet PA passes the main feed roller 33 is low when the leading end area 56 passes, lower when the binding area 58 than when the leading end area 56 passes, and greater when the trailing end area 57 passes than when the leading end area 56 passes. This change in the conveyance load is the same on the supply roller 31 (supply motor 41), and the supply motor 41 current detected by the first current detector 66 changes according to the change in the conveyance load. The change in the current of the supply motor 41 can therefore be made the same as the change in the conveyance load of the main feed motor 43.

During PID control in this embodiment of the invention, the control unit 14 therefore changes control parameters of the main feed motor 43 (first motor) according to the change in the current detected by the first current detector 66 connected to the supply motor 41 (second motor) to maintain the target conveyance precision of the booklet PA. More specifically, control parameters corresponding to the change in the current detected by the first current detector 66 are stored in stages in the control table 68.

The speed of the main feed motor 43 is detected by the main feed encoder 44. During printing conveyance, the speed and stop position of the booklet PA are calculated based on the output of the main feed encoder 44. In PID control in this instance, a control constant (gain) for PID control is changed to obtain the control amount so that the calculated speed and stop position go to the desired target values.

A threshold value for determining if a paper jam (motor overload) occurs with the booklet PA is set according to the change in current for PID control in this embodiment. This threshold value is also previously stored in the control table 68. The control unit 14 acquires the current detected by the second current detector 67 of the main feed motor driver 65, and if the detected current exceeds the threshold current, stops the main feed motor 43 through the main feed motor driver 65.

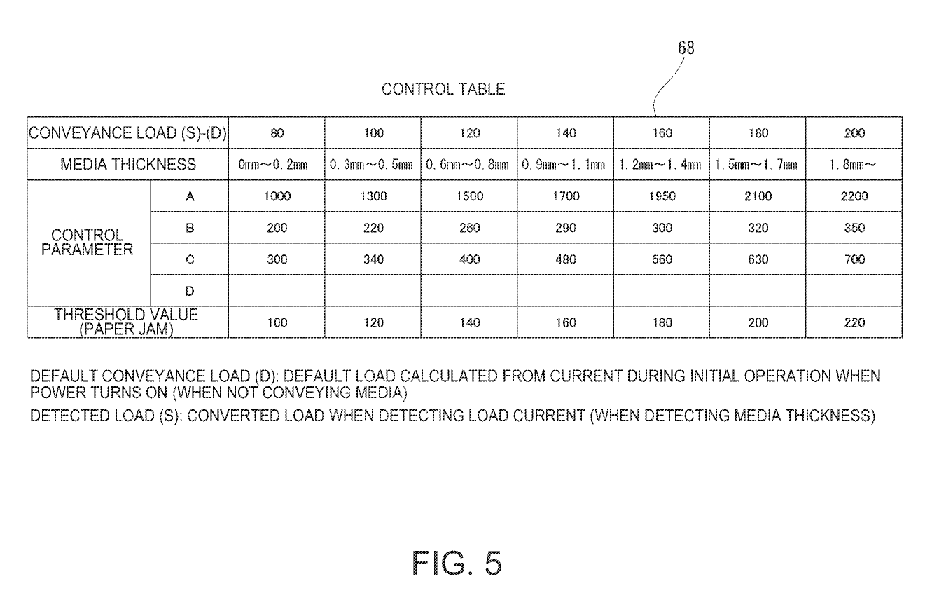

FIG. 5 shows an example of the control table 68 of the control unit 14. As shown in the figure, the conveyance load is the difference (S−D) of the converted load S of the current detected by the first current detector 66 when the booklet PA is conveyed and passes the supply roller 31 minus the converted load D of the initial current (when not conveying media) when the power turns on, for example. In this example, a conveyance load value of 80 means a value in the range 0 to 80, and a value of 100 means a value of 81 to 100.

Media thickness is the thickness of the booklet PA between the drive roller RA and driven roller RB, and is the target thickness for that conveyance load. The media thickness and conveyance load are proportional, and the conveyance load increases as the media thickness increases. As will be understood from the thickness range of the media thickness, when the control amount changes in stages according to the conveyance load, the booklet PA can be desirably conveyed (as described further below) by changing the control amount in two ranges, the leading end area 56 and trailing end area 57 of the booklet PA.

Control parameter A in this example is the proportional constant (proportional gain) in proportional operation (P operation), B is the integral constant (integral gain) in integral operation (I operation), and C is the derivative constant (derivative gain) in derivative operation (D operation). A control constant (gain) in each control operation is thus changed to determine the control amount in PID control.

The threshold value is a decision standard for determining whether or not a paper jam occurred, and is the sum of the conveyance load plus a constant load conversion factor. In this example, the threshold value is the conveyance load plus a constant load conversion factor of 20. The threshold value for paper jams is thus set appropriately to the conveyance load, preventing tearing the booklet PA or unnecessarily stopping the main feed motor 43, for example.

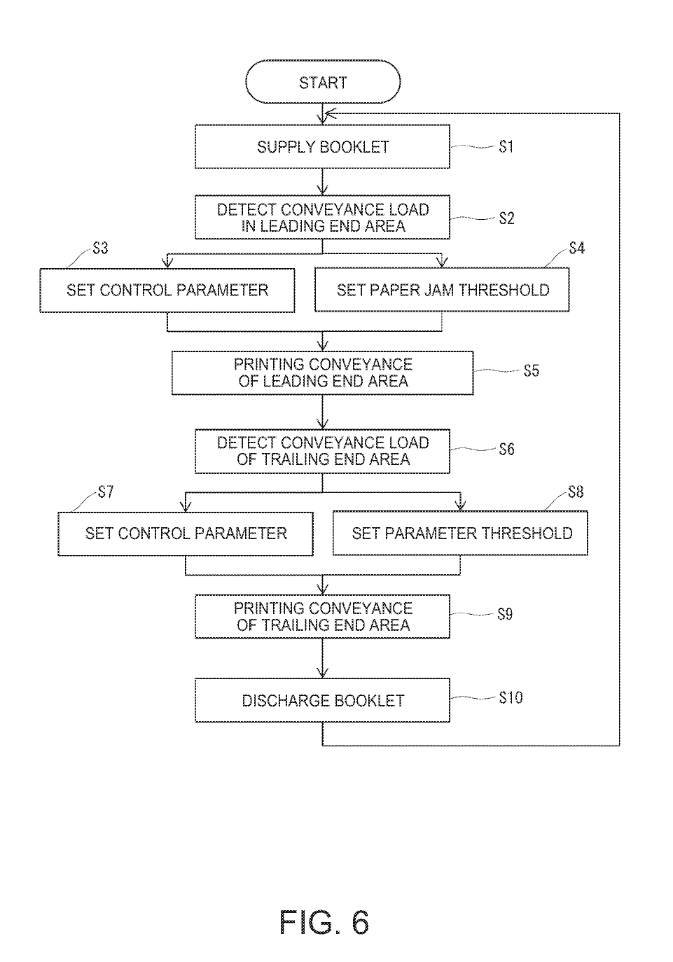

The main feed roller 33 conveyance operation of the booklet PA is described next with reference to the flow chart in FIG. 6. Note that in the conveyance operation described below, the control amount changes in two areas, the leading end area 56 and trailing end area 57 of the booklet PA as described above. Note also that the alignment operation of the booklet PA by the alignment plate 32 is omitted below.

As shown in FIG. 6, when insertion of a booklet PA is detected by the insertion detector 51, the supply roller 31 is driven through the supply motor 41 and the booklet PA is supplied (S1). When the booklet PA is supplied, the leading end area 56 is first nipped by the supply roller 31, and the conveyance load of the leading end area 56 is detected as a current value by the first current detector 66 (S2). The detected current is acquired by the control unit 14, the control table 68 is referenced, and the control parameters of the main feed motor 43 are set (S3). Parallel to step S3, the control table 68 is referenced based on the detected current, and the paper jam threshold value is set (S4).

When it is determined based on the current detected by the second current detector 67 that the leading end of the booklet PA reached the main feed roller 33, the main feed motor 43 is driven by the control amount derived from the control parameters described above, and the leading end area 56 is conveyed for printing (S5). The portion of the booklet PA conveyed by the supply roller 31 changes from the leading end area 56 to the trailing end area 57 during printing conveyance of the leading end area 56.

When the portion of the booklet PA held and conveyed by the supply roller 31 is the trailing end area 57, the conveyance load of the trailing end area 57 is detected as a current value by the first current detector 66 (S6). The current detected at this time is acquired by the control unit 14, the control table 68 is referenced, and new control parameters of the main feed motor 43 are set (S7). The paper jam threshold value is also set parallel to step S7 (S8).

When it is determined based on the current detected by the second current detector 67 that the binding 58a has passed and the leading end of the trailing end area 57 has reached the main feed roller 33, the main feed motor 43 is driven the control amount derived from the set control parameters described above, and the trailing end area 57 is conveyed for printing (S9). As the trailing end area 57 is conveyed for printing, the leading end of the booklet PA reaches the discharge roller 35. The booklet PA is thus nipped by the discharge roller 35, and when printing conveyance by the main feed roller 33 and secondary conveyance roller 34 ends, the discharge motor 46 is driven and the booklet PA is discharged from the paper exit 3 by the discharge roller 35 (S10).

While not shown in FIG. 6, when the second current detector 67 detects current exceeding the threshold current during printing conveyance of a booklet PA, the control unit 14 determines the main feed motor 43 is in an overload state, that is, that a paper jam occurred, stops driving the conveyance mechanism, including the main feed motor 43, and reports a paper jam on the display, for example.

As described above, because this embodiment of the invention changes control parameters of the main feed motor 43 based on the output of the first current detector 66 to maintain a target conveyance precision of the booklet PA (print medium P), conveyance of the booklet PA can be controlled in steps appropriate to the conveyance load of the booklet PA. As a result, conveyance precision, including the conveyance speed and stop position of the booklet PA during printing conveyance, can be increased. The print quality of the booklet PA can therefore be improved.

A paper jam threshold value for the booklet PA is also set according to change in the conveyance load, and this threshold value can be used to determine when a paper jam occurs and quickly stop the printing device 1. Tearing the booklet PA and unnecessarily stopping the printing device 1 can therefore be effectively prevented.

This embodiment of the invention also controls the main feed motor 43 based on output from the first current detector 66, but the main feed motor 43 may alternatively be controlled based on output from the second current detector 67.

Further alternatively, a dedicated roller (or current detector) for detecting the conveyance load may also be provided.

Further alternatively, when there is an extreme change in the conveyance load at the binding area 58, the main feed motor 43 may also be controlled in the binding area 58 as well as the leading end area 56 and trailing end area 57.

The invention being thus described, it will be obvious that it may be varied in many ways. Such variations are not to be regarded as a departure from the spirit and scope of the invention, and all such modifications as would be obvious to one skilled in the art are intended to be included within the scope of the following claims.

What is claimed is:

1. A printing device comprising:
a media conveyance unit that is driven by a DC motor and conveys an open booklet;
a print unit that prints on the booklet conveyed by the media conveyance unit;
a current detection unit that detects the current supplied to the DC motor; and
a control unit that controls driving the DC motor based on a control parameter, and changes the control parameter of the DC motor according to change in the current detected by the current detection unit.

2. The printing device described in claim 1, wherein:
the current changes according to change in the conveyance load on the DC motor during conveyance of the booklet.

3. The printing device described in claim 1, wherein:
the control unit has a control table storing the control parameter corresponding to the current detected by the current detection unit.

4. The printing device described in claim 1, wherein:
the print unit has an inkjet head that moves in a main scanning direction; and
the media conveyance unit intermittently conveys the booklet in a direction perpendicular to the main scanning direction synchronized to driving the inkjet head.

5. The printing device described in claim 1, wherein:
the control parameter includes a gain parameter for PID (proportional-integral-derivative) control.

6. The printing device described in claim 1, wherein:
the media conveyance unit includes a media conveyance roller driven by the DC motor that conveys the booklet to the print unit.

7. The printing device described in claim 1, wherein:
the media conveyance unit includes a media conveyance roller that conveys the booklet to the print unit, and a supply conveyance roller that supplies the booklet to the media conveyance roller;
the DC motor includes a first motor that drives the media conveyance roller, and a second motor that drives the supply conveyance roller;
the current detection unit detects change in the current of the second motor; and
the control unit changes the control parameter of the first motor according to change in the current of the second motor.

8. The printing device described in claim 1, wherein:
the control unit sets a threshold value according to change in the current detected by the current detection unit, and
stops the DC motor when the current detected by the current detection unit exceeds the threshold value.

9. The printing device described in claim 1, wherein:
the control unit has a control table storing the threshold value corresponding to the current detected by the current detection unit.

10. A control method of a printing device that conveys an open booklet driven by a DC motor when printing, the control method comprising:
detecting the current supplied to the DC motor;
changing a control parameter of the DC motor according to change in the detected current; and
driving the DC motor based on the control parameter.

11. The control method of a printing device described in claim 10, wherein:
the detected changes according to change in the conveyance load on the DC motor during conveyance of the booklet.
